(19) United States
(12) Patent Application Publication
(10) Pub. No.: US 2005/0209125 A1
(43) Pub. Date: Sep. 22, 2005

(54) Detergent compositions comprising a modified polyaminoamide

(76) Inventors: Xinbei Song, Cincinnati, OH (US); Pramod Kakumanu Reddy, Schwalbach Am Taunus (DE); Jeffrey John Scheibel, Loveland, OH (US); Jurgen Detering, Limburgerhof (DE); Cordula Mock-Knoblauch, Ludwigshafen (DE)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/083,649

(22) Filed: Mar. 18, 2005

Related U.S. Application Data
(60) Provisional application No. 60/554,998, filed on Mar. 19, 2004.

(51) Int. Cl. C11D 17/00

(52) U.S. Cl. 510/499

(57) ABSTRACT

Detergent compositions containing modified polyaminoamides and a surfactant system for improved soil cleaning and soil dispersing.

### CROSS REFERENCE TO RELATED APPLICATION

This application claims priority under 35 U.S.C. § 119(e) to U.S. provisional application No. 60/554998, filed Mar. 19, 2004.

### FIELD OF THE INVENTION

The present application relates to detergent compositions which have good soil removal properties and good dispersing properties for hydrophobic particulate soil, especially clay minerals through the use of modified polyaminoamides.

### BACKGROUND OF THE INVENTION

Certain polymers are known to be useful for preventing the redeposition of soil by stabilizing the soil in the wash liquor. Amongst these are carboxymethylcellulose (CMC), huminic acid, polyacrylic acid and copolymers of maleic acid and acrylic acid (see Powdered Detergents, Editor: Michael S. Showell, Surfactant Sci. Ser., Vol. 71, Marcel Decker, New York 1998, pages 111-114; Liquid Detergents, Editor: Kuo-Yann Lai, Surfactant Sci. Ser., Vol. 67, Marcel Decker, New York 1997, page 303).

Polyaminoamides are known to be polymers whose backbone chain contains both amino functionalities (NH) and amide functionalities (NH—C(O)). Modified polyaminoamides containing polyether side chains, which are attached to the amino nitrogen atoms of the polymer backbone and, if present, to the amino nitrogen atoms of the end-groups of the polymer, are known e.g. from GB 1218394, EP 1025839, EP 1192941 and WO03/050219. In the modified polyaminoamides of prior art the number average of the repeating units in the polyether side chain is in most cases from 1 to 6. Up to now, polyaminoamides have neither been suggested as anti- redeposition agents nor to be useful for assisting in soil removal. Consequently, there is ongoing need for compounds which are useful as detergent auxiliaries for preventing redeposition of soil and for assisting in soil removal.

### SUMMARY OF THE INVENTION

The present application relates to detergent composition comprising from about 0.01% to about 90% by weight of the detergent composition of a surfactant system and from about 0.01% to about 20% by weight of the detergent composition of a modified polyaminoamide comprising formula (I) 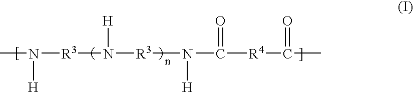
wherein n of formula (I) is an integer from 1 to 500; R³ formula (I) is selected from an C₂-C₈ alkanediyl, preferably 1,2-ethanediyl or 1,3-propane diyl; R⁴ formula (I) is selected from a chemical bond, C₁-C₂₀-alkanediyl, C₁-C₂₀-alkanediyl comprising 1 to 6 heteroatoms selected from the group consisting of oxygen, sulfur, and nitrogen, C₁-C₂₀-alkanediyl comprising 1 to 6 heteroatoms selected from the group consisting of oxygen, sulfur, and nitrogen further comprising one or more hydroxyl groups, a substituted or unsubstituted divalent aromatic radical, and mixtures thereof; wherein formula (I) comprises secondary amino groups of the polymer backbone, the secondary amino groups comprise amino hydrogens, the amino hydrogens are selectively substituted in the modified polyaminoamide such that the modified polyaminoamide comprises partial quaternization of the secondary amino groups by selectively substituting at least one amino hydrogen with at least one alkoxy moiety of formula (II):
—(CH₂—CR¹R²—O—)ₚA (II)
wherein A of formula (II) is selected from a hydrogen or an acidic group, the acidic group being selected from —B¹—PO(OH)₂, —B¹—S(O)₂OH and —B²—COOH; such that B¹ of formula (II) is a single bond or C₁-C₆-alkanediyl; and B² of formula (II) is C₁-C₆-alkanediyl; R¹ formula (II) is independently selected from hydrogen, C₁-C₁₂-alkyl, C₂-C₈-alkenyl, C₆-C₁₆-aryl or C₆-C₁₆-aryl-C₁-C₄-alkyl; R² of formula (II) is independently selected from hydrogen or methyl; and p of formula (II) is an integer comprising a number average of at least 10;
With the remainder of the amino hydrogens of the secondary amino groups being selected from the group comprising electron pairs, hydrogen, C₁-C₆-alkyl, C₆-C₁₆-aryl-C₁-C₄-alkyl and formula (III) Alk-O-A, wherein
A of formula (III) is hydrogen or an acidic group, the acidic group being selected from —B¹—PO(OH)₂, —B¹—S(O)₂OH and —B²—COOH; such that B¹ of formula (III) is selected from a single bond or a C₁-C₆-alkanediyl; and B² of formula (III) is selected from a C₁-C₆-alkanediyl, and Alk of formula (III) is C₂-C₆-alkane-1,2-diyl;
the secondary amino groups of formula (I) are further selected to comprise at least one alkylating moiety of formula (IV):
   —RX (IV)
   Wherein R of formula (IV) is selected from the group consisting of: C₁-C₆-alkyl, C₆-C₁₆-aryl-C₁-C₄-alkyl and formula (III) Alk-O-A, formula (II) —(CH₂—CR¹R²—O—)ₚA.

### DETAILED DESCRIPTION OF THE INVENTION

The present application relates to detergent compositions comprising modified polyaminoamides. These compositions can be in any conventional form, namely, in the form of a liquid, powder, granules, agglomerate, paste, tablet, pouches, bar, gel, types delivered in dual-compartment containers, spray or foam detergents, premoistened wipes (i.e., the detergent composition in combination with a nonwoven material such as that discussed in U.S. Pat. No. 6,121,165, Mackey, et al.), dry wipes (i.e., the detergent composition in combination with a nonwoven materials, such as that discussed in U.S. Pat. No. 5,980,931, Fowler, et al.) activated with water by a consumer, and other homogeneous or multiphase consumer cleaning product forms.

Often these detergent compositions will additionally comprise surfactants and other detergent adjunct ingredients, discussed in more detail below. In one embodiment, the detergent composition of the present application is a liquid or solid laundry detergent composition.

The modified polyaminoamides comprise modification of at least a part of the amino nitrogens of the polymer backbone and, if present, of the amino end groups as defined below and optionally further modification via an esterification moiety or etherification moiety as defined below.

As used herein “amino hydrogen(s)” means the hydrogen atoms that are bound to the secondary amino groups of the polymer backbone and, if present, to the to the primary amino groups at the termini of the non-modified polyaminoamide starting material in order to distinguish them from the hydrogens bound to the amide nitrogens in the polymer backbone.

The term “C₁-C₁₂-alkyl” as used herein refers to a saturated straight-chain or branched hydrocarbon radical having 1 to 12, preferably from 1 to 6 carbon atoms, for example methyl, ethyl, propyl, 1-methylethyl, butyl, 1-methylpropyl, 2-methylpropyl, 1,1-dimethylethyl, n-pentyl, 1-methylbutyl, 2-methylbutyl, 3-methylbutyl, 2,2-dimethylpropyl, 1-ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, n-heptyl, n-octyl, isooctyl, 2-ethylbexyl, n-nonyl, 2-nonyl (isononyl), n-decyl or n-dodecyl.

The term “C₂-C₁₂-alkenyl” as used herein refers to a straight-chain or branched monounsaturated hydrocarbon radical having 2 to 12, preferably from 2 to 6 and especially from 2 to 4 carbon atoms and a double bond in any position, i.e., for example ethenyl, 1-propenyl, 2-propenyl, 1-methyl-ethenyl, 1-butenyl, 2-butenyl, 3-butenyl, 1-methyl-1-propenyl, 2-methyl-1-propenyl, 1-methyl-2-propenyl, 2-methyl-2-propeny, and the like.

The term “C₆-C₁₆-aryl” as used herein refers to an aromatic hydrocarbon radical having from 6 to 16 carbon atom such as phenyl or naphthyl which may carry 1, 2, 3 or 4 substituents selected from C₁-C₁₂-alkyl and C₂-C₁₂-alkenyl, wherein 2 substituents on adjacent carbon atoms may form a ring such as in tetrahydronaphthyl or in indanyl.

The term “C₆-C₁₆-aryl-C₁-C4-alkyl” as used herein refers to a saturated straight chain or branched hydrocarbon radical having 1 to 4 carbon atoms, which carries a C₆-C₁₆-aryl group. Examples are benzyl, 1-phenylethyl and 2-phenylethyl.

The term “Cₓ-C_{y}-alkanediyl” refer to a bivalent alkylene chain having from x to y carbon atoms as indicated in the subscript (e.g., C₁-C₂₀-alkanediyl). Examples of alkandiyl are methylen (CH₂), ethane-1,1-diyl, ethane-1,2-diyl, propane-1,1-diyl, propane-1,2-diyl, propane-2,2-diyl, butane-1,3-diyl, butane-1,4-diyl, butane-2,2-diyl, butane-2,3-diyl, and the like.

Incorporated and included herein, as if expressly written herein, are all ranges of numbers when written in a “from X to Y” format. It should be understood that every limit given throughout this specification will include every lower, or higher limit, as the case may be, as if such lower or higher limit was expressly written herein. Every range given throughout this specification will include every narrower range that falls within such broader range, as if such narrower ranges were all expressly written herein.

Modified Polyaminoamide

The present application relates to detergent compositions comprising from about 0.01% to about 20%, preferably from about 0.01% to about 10%, more preferably from about 0.01% to about 8%, by weight of the detergent composition, of a modified polyaminoamide.

The modified polyaminoamides according to the application have, depending on their degree of alkoxylation, a number average molecular weight (Mₙ) of from 1,000 to 1,000,000, preferably from 2,000 to 1,000,000 and more preferably from 2,000 to 50,000.

In general, polyaminoamides are polymers whose backbone chain contains both amine functionalities (*—NH—*) and amide functionalities (*—NH—C(O)—*); the asterisks indicate the polymer backbone. Polyaminoamides also contain primary amino groups (—H₂) and/or carboxyl groups (—COOH) at the termini of the polymer chain. As used herein, the term “amino” comprises both the secondary amine functionalities of the polymer backbone and the primary amine functionalities at the termini of the polymer chain. In general polyaminoamides are linear.

The modified polyaminoamide of the detergent composition of the present application comprises formula (I) 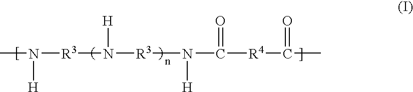
wherein n of formula (I) is an integer from 1 to 500, preferably form 1 to 100, more preferred from 1 to 20, more preferred from 1 to 10 and most preferred 1, 2 or 3. R³ of formula (I) is selected from C₂-C₈-alkanediyl, preferably C₂-C₈-alkanediyl and more preferred 1,2-ethanediyl or 1,3-propane diyl. R⁴ of formula (I) is selected from a chemical bond, C₁-C₂₀-alkanediyl, C₁-C₂₀-alkanediyl comprising 1 to 6 heteroatoms selected from the group consisting of oxygen, sulfur, and nitrogen (imino), C₁-C₂₀-alkanediyl comprising 1 to 6 heteroatoms selected from the group consisting of oxygen, sulfur, and nitrogen (imino) further comprising one or more hydroxyl groups, a substituted or unsubstituted divalent aromatic radical, and mixtures thereof. The C₁-C₂₀-alkanediyl comprising 1 to 6 heteroatoms selected from the group consisting of oxygen, sulfur, and nitrogen (imino) may contain 1 or 2 carbon-carbon-double bonds. The C₁-C₂₀-alkanediyl comprising 1 to 6 heteroatoms selected from the group consisting of oxygen, sulfur, and nitrogen (imino)may, completely or partially, be a constituent of one or more saturated or unsaturated carbocyclic 5- to 8-membered rings. Preferably R⁴ is C₂-C₆-alkanediyl.

The modified polyaminoamide comprising formula (I) comprises secondary amino groups of the polymer backbone. The secondary amino groups comprise amino hydrogens and the amino hydrogens are selective substituted to result in the modified polyaminoamide comprising partial quaternization of the secondary amino groups by selectively substituting at least one amino hydrogen with at least one alkoxy moiety of formula (II):
—(CH₂—CR¹R²—O—)ₚA (II)
wherein A of formula (II) is selected from a hydrogen or an acidic group, the acidic group being selected from —B¹—PO(OH)₂, —B¹—S(O)₂OH and —B²—COOH, which may be present in the acidic or anionic form. Preferably A is selected from hydrogen —B¹—PO(OH)₂, and —B¹—S(O)₂OH. B¹ of formula (II) is selected from a single chemical bond or C₁-C₆-alkanediyl. B² of formula (II) is selected from a C₁-C₆-alkanediyl.
R¹ of formula (II) is independently selected from hydrogen, C₁-C₁₂-alkyl, C₂-C₈-alkenyl, C₆-C₁₆-aryl or C₆-C₁₆-aryl-C₁-C₄-alkyl, preferably hydrogen and C₁-alkyl (methyl).
R² of formula (II) is independently selected from hydrogen or methyl, preferably hydrogen.

The index p of formula (II) is an integer comprising a number average of at least 10. The number average of p in formula (II) is preferably at least 15 and more preferably at least 21. Usually the number average of p does not exceed 200, preferably 150 and more preferred 100. Most preferably the number average of p ranges from 15 to 70, especially 21 to 50.

The remainder of the amino hydrogens of the secondary amino groups are selected from the group comprising electron pairs, hydrogen, C₁-C₆-alkyl, C₆-C₁₆-aryl-C₁-C₄-alkyl and formula (III):
Alk-O-A (III)
A of formula (III) is selected from a hydrogen or an acidic group, the acidic group being selected from —B¹—PO(OH)₂, —B¹—S(O)₂)H and —B²—COOH, which may be present in the acidic or anionic form. Preferably A is selected from hydrogen, —B¹—PO(OH)₂, and —B¹—S(O)₂OH. B¹ of formula (II) is selected from a single chemical bond or C₁-C₆-alkanediyl. B² of formula (II) is selected from a C₁-C₆-alkanediyl. Alk of formula (V) is selected from a C₂-C₆-alkane-1,2-diyl.

The secondary amino groups of formula (I) is selected to further comprise at least one alkylating moiety of formula (IV):
—RX (IV)
R of formula (IV) is selected from the group consisting of C₁-C₆-alkyl, C₆-C,₆-aryl-C₁-C₄-alkyl and formula (III) Alk-O-A, and formula (II) —(CH₂—CR¹R²—O—)ₚA.
X of formula (IV) is a leaving group capable of being replaced by nitrogen, and epoxides having from 2 to 6 carbon atoms, usually C₂-C₆-alkylene oxides. Suitable leaving groups X of formula (IV) are halogen, especially chlorine, bromine or iodine, sulfate (i.e. —O—SO₃H or —O—SO₃⁻), alkylsulfonate such as methylsulfonate, arylsulfonate such as tolylsulfonate, and alkyl sulfate, such as methosulfate (i.e. —O—SO₂—OCH₃). Preferred alkylating moieties are C₁-C₆-alkyl halides, Bis-(C₁-C₆-alkyl)sulfates and benzyl halides. Examples of such alkylating agents are ethyl chloride, ethyl bromide, methyl chloride, methyl bromide, benzyl chloride, dimethyl sulfate and diethyl sulfate. Preferred C₂-C₆-alkylene oxides are ethylene oxide and propylene oxide.

The modified polyaminoamide may further be selected to comprise an esterifying or etherifying moiety of any hydroxy groups that may be present in formulae (II), (III), (IX), (X), (XI), and (XII), discussed below. Suitable esterifying moieties may be selected from sulphuric acid, phosphoric acid, and ester-forming derivates of the same. Suitable etherifying moieties are selected from the formula (V) L-B³-A′, wherein A′ of formula (V) is selected from —COOH, —SO₃H, and —PO(OH)₂, B³ of formula (V) is selected from Cl-C₆-alkandiyl; and L of formula (V) is a leaving group that can be replaced by nucleophiles.

The modified polyaminoamide of the detergent composition of the present application further comprises aliphatic, aromatic or cycloaliphatic diamines as shown in formula (VI): 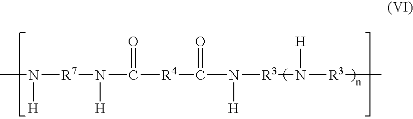
Wherein R³, R⁴, and the index n of formula (VI) are the same as that defined in formula (I). R⁷ of formula (VI) is a bivalent organic radical carrying from 1 to 20 carbon atoms, C₁-C₂₀-alkanediyl, C₁-C₂₀-alkanediyl comprising 1 to 6 heteroatoms selected from the group consisting of oxygen, sulfur, and nitrogen (imino), C₁-C₂₀-alkanediyl comprising 1 to 6 heteroatoms selected from the group consisting of oxygen, sulfur, and nitrogen (imino) further comprising one or more hydroxyl groups, a substituted or unsubstituted divalent aromatic radical, and mixtures thereof. The C₁-C₂₀-alkanediyl comprising 1 to 6 heteroatoms selected from the group consisting of oxygen, sulfur, and nitrogen (imino) may contain 1 or 2 carbon-carbon-double bonds. The C₁-C₂₀-alkanediyl comprising 1 to 6 heteroatoms selected from the group consisting of oxygen, sulfur, and nitrogen (imino) may, completely or partially, be a constituent of one or more saturated or unsaturated carbocyclic 5- to 8-membered rings. R⁷ of formula (VI) when selected to be a divalent aromatic radical, preferably is selected from 1,2-, 1,3 or 1,4-phenylene. The divalent aromatic radical may also carry 1, 2 or 3 substituents, selected from C₁-C₄-alkyl, C₁-C₄-alkoxy, C₃-C₇-cycloalkyl, halogen, hydroxy and the like. Preferably R⁷ of formula (VI) is a C₁-C₄ alkanediyl or a C₄-C₂₀-alkanediyl that is interrupted by 1, 2, 3 or 4 nonadjacent oxygen atoms.

One embodiment of the modified polyaminoamides of the application comprise the formula (VII):

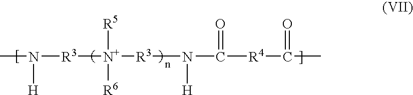

The index n and R³of formula (VII) is the same as that described in formula (I). R⁴ of formula (VII) is a chemical bond, C₁-C₂₀ alkanediyl, C₁-₂₀ alkanediyl interrupted by oxygen, sulfur, and/or an imino groups which may contain 1 or 2 carbon-carbon double bonds, completely or partially, one or more saturated or unsaturated carboxcyclic 5-to 8-memberd rings, where the alkanediyl may carry one or more hydroxyl groups. Preferably R⁴ is C₂-C₆-alkanediyl.
R⁵ of formula (VII) is the is selected from hydrogen, C₁-C₆-alkyl, C₆-C₁₆-aryl-C₁-C₄-alkyl and formula (III) Alk-O-A, and formula (II) —(CH₂—CR¹R²—O—)ₚA.
R⁶ of formula (VII) is present at least once as formula (II) —(CH₂—CR¹R²—O—)ₚA with the remainder of any R⁶ of formula (VII) is selected from an electron pair (i.e., nonquatemized), hydrogen, C₁-C₆-alkyl, C₆-C₁₆-aryl-C₁-C₄-alkyl, formula (III) Alk-O-A, and formula (III) —(CH₂—CR¹R²—O—)ₚA.

One embodiment of the modified polyaminoamides of the application comprise the formula (VIII): 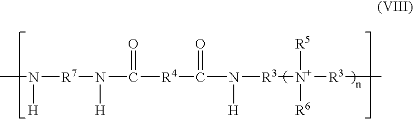
Wherein R³, R⁴, and the index n of formula (VIII) are the same as that defined in formula (I). R⁷ of formula (VIII) is the same as defined in formula (VI). R⁵ and R⁶ of formula (VIII) are the same as defined in formula (VII).

In formulae (II), (VI), (X), and (XI), it is preferred in at least 30 mol %, more preferably in at least 50 mol % of the repeating units CH₂—CR¹R²—O of formula (II), both R¹ and R² of formula (II) are hydrogen.

In another preferred embodiment, formula (II) comprises at least 90 mol % repeating units of the formula CH₂—CH₂—O, i.e. both R¹ and R² of formula (II) are hydrogen.

In another preferred embodiment, formula (II) comprises from 10 to 70 mol %, preferably from 10 to 50 mol% repeating units of the formula CH₂—CH(CH₃)—O and from 30 to 90 mol %, especially from 50 to 90 mol % of repeating units CH₂—CH₂—O. In this embodiment the different repeating units may be arranged randomly or preferably blockwise.

In the modified polyaminoamides of the present application at least a part of the amino groups, i.e., the amino groups in the polymer backbone, is selected to be quarternized functionalities as shown in the formula (a): 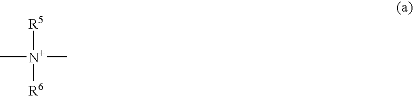
R⁵ of formula (a) is same as that defined by formula (VII). R⁶ of formula (a) is the same as that defined by formula (VII).

If present, the primary (terminal) amino groups of the modified polyaminoamide according to the application may also selected to be quaternized as shown in the formulae (b1) and (b2): 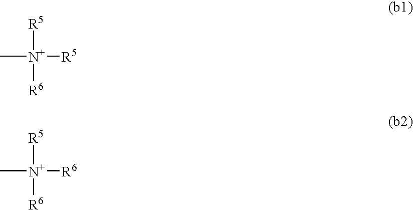
R⁵ of formulae (b1) and (b2) is same as that defined by formula (VII). R⁶ of formulae (b1) and (b2) is the same as that defined by formula (VII).

In the modified polyaminoamide of the application at least a part of the amino nitrogen atoms of the polymer are replaced by quaternized functionalities of the formulae (a), (b1) and (b2) as described above. Preferably at least 50 mol %, more preferably at least 70 mol % of the amino groups in the polymer is quaternized. Preferably the amount of quaternized moieties in formulae (a), (b1) and (b2) in the modified polyaminoamides of the application is from 0.1 mol/kg to 3.0 mol/kg and preferably from 0.2 mol/kg to 2 mol/kg.

The amount of the quaternized moieties can be calculated from the difference of the amine number in the non-quarternized product and the quaternized polyaminoamide. The amine number can be determined according to the method described in DGF standard methods—c section H—surfactants, method H-III 20a (98) “Potentiometric titration of the total basic nitrogen I surfactants” (DGF Einheitsmethoden—Abteilung H—Tenside, Methode H-III 20a (98) “Potentiometrische Titration des Gesamtbasenstickstoffs von Tensiden”).

In the modified polyaminoamides of the application, wherein A of formulae (II) and (III) is an acidic group, the acidic group may be present in the neutralized (anionic) form or in the acidic (i.e. the neutral) form. The net charge of the modified polyaminoamide will therefore depend on the relative molar amounts of acidic groups to quaternized moieties (i.e., when both the alkoxy moiety and alkylating moiety are on the same nitrogen of the backbone; R⁵ and R⁶ of formulae (VII) and (a), (b1), and (b2) are both present on the same backbone in sufficient amounts to give quaternization), on the number of charges per acidic group and on the degree of neutralization of the acidic groups.

Suitable counterions to compensate the net-charge of the modified polyaminoamide when the net charge of the modified polyaminoamide is positive, is selected from mineral acids. Preferred mineral acids include sulfate, hydrogensulfate, monoalkylsulfate, phosphate, hydrogenphosphate, chloride, and the like. Suitable counterions to compensate the net-charge of the modified polyaminoamide when the net charge of the modified polyaminoamide is negative, is selected from alkaline metal ions such as sodium, ammonium ions such as NH₄⁺, ammionium ions derived from ethanol amine, diethanol amine, triethanol amine, methyl diethanol aminine, and the like.

In a first embodiment of the application, R of formula (IV) is selected from a C₁-C₆-alkyl or benzyl, preferably methyl, ethyl or benzyl. In another embodiment of the application R of formula (IV) is formula (III) [Alk-O-A] as defined above, with preference given to ethane-1,2-diyl and propane-1,2-diyl.

In a preferred embodiment of the application, at least 25 mol % and especially at least 50 mol % of formula (II) and, if present, formula (III) carry an acidic/anionic group A, i.e., A is different from hydrogen. In particular the acidic group is selected from B¹—PO(OH)₂ and B¹—S(O)₂OH wherein B¹ of formula (II) and (III) is as defined above and especially a single bond. In another embodiment of the application the acidic group is B²—COOH of formula (II) and (III), and especially CH₂—COOH.

In a preferred embodiment, the detergent composition comprises a modified polyaminoamide of formula (IX): 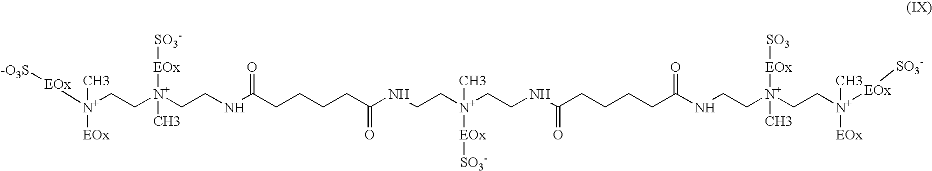
wherein x of formula (IX) is from 10 to 200, preferably from about 15 to about 150, most preferably from about 21 to about 100. Most preferably the number average of x of formula (IX) ranges from 15 to 70, especially 21 to 50. EO in formula (IX) represents ethoxy moieties.

In another preferred embodiment, the detergent composition comprises a modified polyaminoamide wherein the ratio of dicarboxylic acid:polyalkylenepolyamines is 4:5 and 35:36; the polyalkylenepolyamine is quatemized as described in formula (a), (b1) and (b2) above.

Process

Non-modified polyaminoamide, which are used as starting materials in the process of producing the modified polyaminoamide, for use in the detergent composition of the present application, is usually a condensate of a dicarboxylic acid with a polyalkylenpolyamine and optionally with an aliphatic, aromatic or cycloaliphatic diamine.

Suitable dicarboxylic acids and the amide-forming derivatives thereof for producing the non-modified polyaminoamides are represented by formula (X):
HOOC—R⁴—COOH (X)
R⁴ of formula (X) is as described in formula (I). Preferably R⁴ of formula (X) is C₂-C₆-alkanediyl.

Suitable dicarboxylic acids are, in particular, those with 2 to 10 carbon atoms, such as oxalic acid, malonic acid, succinic acid, tartaric acid, maleic acid, itaconic acid, glutaric acid, adipic acid, suberic acid, sebacic acid, phthalic acid and terephthalic acid. Also suitable are dibasic amino acids, such as iminodiacetic acid, aspartic acid and glutamic acid. Preferred acids are adipic acid, glutaric acid, aspartic acid and iminodiacetic acid. The dicarboxylic acids can of course be used in a mixture with one another. In an especially preferred embodiment of the application the dicarboxylic acid is adipic acid.

Suitable amide-forming derivatives of dicarboxylic acids are anhydrides, esters, amides or acid halides, in particular chlorides. Examples of such derivatives are maleic anhydride, succinic anhydride, phthalic anhydride and itaconic anhydride; adipic dichloride; esters with, preferably, C₁-C₂-alcohols, such as dimethyl adipate, diethyl adipate, dimethyl tartrate and dimethyl iminodiacetate; amides, such as adipic acid diamide, adipic acid monoamide and glutaric acid diamide. Preference is given to using the free carboxylic acids or the carboxylic anhydrides.

As used herein “polyalkylenepolyamines” are to be understood as meaning compounds that consist of a saturated hydrocarbon chain with terminal amino functions that is interrupted by at least one secondary amino group (imino group). Suitable polyalkylenepolyamines can be described by formula (XI):
H₂N—R³—(NH—R³)ₙ—NH₂ (XI)
The index n and R³ of formula (XI) is as described in formula (I).

Suitable polyalkylenepolyamines include diethylenetriamine, triethylenetetramine, tetraethylenpentamine, pentaethylenehexamine, diaminopropylethylenediamine (N,N′-bis(3-aminopropyl)-1,2-diaminoethane), ethylenepropylenetriamine, 3-(2-aminoethyl)aminopropylamine, dipropylenetriamine, bis(hexamethylene)triamine and polyethyleneimines with molar masses of, preferably, 300 to 20,000, in particular from 300 to 5,000. Preference is given to poly-C₂-C₃-alkyleneamines with 3 to 10 nitrogen atoms. Of these, particular preference is given to diethylenetriamine, 3-(2-aminoethyl)aminopropylamine, dipropylenetriamine and diaminopropylethylenediamine. The polyalkylenepolyamines can of course be used in a mixture with one another.

Suitable aliphatic, aromatic or cycloaliphatic diamines can be described by formula (XII):
NH₂—R⁷—NH₂ (XII)
R⁷ of formula (XII) is as described in formula (VII). R⁷ of formula (XII) when selected to be a divalent aromatic radical, preferably is selected from 1,2-, 1,3 or 1,4-phenylene. The divalent aromatic radical may also carry 1, 2 or 3 substituents, selected from C₁-C₄-alkyl, C₁-C₄-alkoxy, C₃-C₇-cycloalkyl, halogen, hydroxy and the like. Preferably R⁷ of (XII) is a C₁-C₆-alkanediyl or a C₄-C₂₀-alkanediyl that is interrupted by 1, 2, 3 or 4 nonadjacent oxygen atoms.

Examples of suitable diamines comprise ethylene diamine, 1,3-propylene diamine, 1,6-hexane diamine, 1,4-diaminocylohexane, bis-(4-aminocyclohexyl)methane, bis(aminopropyl)methylamine, 4,4′-diaminodiphenylmethane, 1,4-bis-(3-aminopropyl)piperazine, 3-oxapentane-1,5-diamine, 3-Oxahexane-1,6-diamine, 4,7-dioxadecane-1,10-diamine 4,8-dioxaundecane-1,11-diamine, 4,9-dioxadodecane-1,12-diamine and 4,7,10-trioxatridecane-1,13-diamine.

The molar ratio of dicarboxylic acid to the total amount of combined polyalkylenepolyamine and the optional diamine [i.e., molar ratio dicarboxylic acid: (polyalkylenepolyamine and optional diamine)] is usually from 2:1 to 1:2, preferably from 1:1 to 1:2, more preferably from 1:1.05 to 1:1.7 and especially from 1:1.1 to 1:1.5.

Usually, the proportion of the diamine does not exceed 50 mol % and preferably 30 mol % of the total molar amount of (polyalkylenepolyamine and optional diamine). If desired, the diamine makes up from 1 to 50 mol %, preferably from 5 to 30 mol % of the total molar amount of (polyalkylenepolyamine and optional diamine). In a preferred embodiment, the diamine makes up less than 5 mol % of the total molar amount of (polyalkylenepolyamine and optional diamine).

Thereby non-modified polyaminoamides, utilized to make the modified polyaminoamides used in the detergent compositions of the present application, have a number average molecular weight (Mₙ) of from 150 to 50,000, preferably from 250 to 10,000. The non-modified polyaminoamides can be characterized by ¹H-, ¹³C- and ¹⁵N-NMR spectroscopy as well as by mass spectrometry (MS). MALDI MS can be used to determine the distribution of molecular weights and the kind of repeating units. By NMR the types of endgroups can be determined. Since the non-modified polyaminoamides have a linear structure, the number average of the molecular weight can be determined from the ratio of the integrals of the NMR-signals.

Modification of the Non-Modified Polyaminoamide

The modified polyaminoamide for use the detergent composition of the claimed application may be produced by the general process:
i) reacting the non-modified polyaminoamide with at least 10 moles, per mol of amino hydrogens in the non-modified polyaminoamide, of at least one epoxide of formula (XIII) 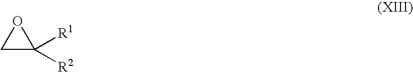
   wherein R¹ and R² are as defined for formula (II);
ii) reacting the modified polyaminoamide of step i) with at least one alkylating moiety, formula (IV) [—RX], wherein R and X are as defined above in formula (IV), thereby obtaining a cationically modified polyaminoamide; and
iii) optionally esterifying/etherifying the hydroxyl groups in the cationically modified polyaminamide obtained in step ii) with:
   (a) sulfuric acid or phosphoric acid or with an ester-forming derivative thereof; or
   (b) etherification of the hydroxyl groups in the cationically modified polyaminamide obtained in step ii) with a compound of the formula (XIV) L-B³-A′, wherein A′ of formula (XIV) is selected from —COOH, —SO₃H and —PO(OH)₂, B³ of formula (XIV) is selected from C₁-C₆-alkandiyl; and L of formula (XIV) is a leaving group, which can be replaced by nucleophiles.

Step i) of the process of the application can be achieved in analogy to know methods of alkoxylating amines. Preferably, the non-modified polyaminoamide starting material is reacted in a first step with an epoxide of formula (XIII) in the absence of a catalyst. A polyaminoamide where most or all of the amino hydrogens are replaced by a radical CH₂—CR¹R²—OH, wherein R¹ and R² of formula (II) is as above with p of formula (II) being equal to 1. To obtain modified polyamidoamines with p of formula (II) being greater than 1, further amounts of epoxide of formula (XIII) is used, preferably in the presence of a base as catalyst. Examples of suitable bases are alkali metal and alkaline earth metal hydroxides, alkali metal alkoxides. sodium hydride; calcium hydride and alkali metal carbonates. Preferred bases are the alkali metal hydroxides and alkali metal alkoxides. The base is generally used in an amount of from 0.05 to 10% by weight, preferably 0.5 to 2% by weight, based on the total amount of the starting materials.

The alkoxylated polyaminoamides obtained in step i) are then reacted with an alkylating moiety (step ii). As used herein, the term “alkylating moiety” refers to a formula (IV) [—RX], wherein R and X is as defined above in formula (IV). See generally Houben-Weyl, Methoden der organischen Chemie, 4^{th} ed., vol. XI/2, p. 608-613. The amount of alkylating moiety determines the amount of quatemization of the amino groups in the polymer backbone, i.e. the amount of quaternized moieties shown in formulae (a), (b1) and (b2). In general, the amount of the alkylating moiety is from 0.1 mol to 2 mol, especially from 0.5 mol to 1.5 mol, and more preferred from 0.7 mol to 1.2 mol per mol of amino groups in the modified polyaminoamide obtained in step i). In general, the amount of epoxides used as alkylating agent is from 0.1 mol to 2 mol, especially from 0.5 mol to 2 mol and more preferred from 0.7 mol to 1.5 mol per mol of amino groups in the modified polyaminoamide obtained in step i).

The thus obtainable cationic modified polyaminoamides carry hydroxyl groups as terminal groups of the formula (II) and, if present, in the form of groups Alk-OH of formulae (III), when A of formula (III) is selected as hydrogen. These hydroxyl groups can be esterified in step iii), thereby esterfied polyaminoamides, wherein A of formulae (II) and (III) is selected from —PO(OH)₂ and —S(O)₂OH. See W. H. de Groot: Sulfonation Technology in Detergent Industry, Kluwer Academic Publ., Dordrecht 1991 (sulfur trioxide acid); WO 02/12179 (di-alkylsulfates); Ullmann's Encyclopedia of Industrial Chemistry, Sixth Edition, 2000 Electronic Release SURFACTANTS—Anionic Surfactants (Kurt Kosswig) 6.3. Sulfates and 6.4 phosphates; THIN-FILM REACTORS—Thin Film Reactors for Industrial Sulfonation (Bernhard Gutsche, Christoph Breucker, Günter Panthel); CHLOROSULFURIC ACID—Chemical Properties (Joachim Maas, Fritz Baunack); Stache (Hrsg.), Anionic Surfactants—Organic Chemistry, S. 647-696, New York: Dekker 1995.

These hydroxyl groups can also be etherified with compounds of the formula (XIV) L-B³-A′ as defined above. The introduction of the formula (XIV) L-B³-A′ at the termini of polyether side chains, especially of a carboxylic acid functionality —B₂—COOH of formulae (II) and (III) can be achieved by etherification of terminal hydroxyl groups with halocarboxylic acids Hal-B²—COOH {Hal=halogen, especially chlorine or bromine, B² of formulae (II) and (III) as defined above, especially with α-halocarboxylic acids such as chloroacetic acid. The etherification can be performed in analogy to known methods for the production of caboxy methylcellulose (Houben-Weyl E20, p. 2072-2076 and Ullman, 5th ed., A5, p. 477-478).

Surfactants—Surfactant that may be used for the present application may comprise a surfactant or surfactant system comprising surfactants selected from nonionic, anionic, cationic surfactants, ampholytic, zwitterionic, semi-polar nonionic surfactants, other adjuncts such as alkyl alcohols, or mixtures thereof.

The detergent composition of the present application further comprises from about from about 0.01% to about 90%, preferably from about 0.01% to about 80%, more preferably from about 0.05% to about 60%, most preferably from about 0.05% to about 30% by weight of the detergent composition of a surfactant system having one or more surfactants.

Anionic Surfactants

Nonlimiting examples of anionic surfactants useful herein include C₁₁-C₁₈ alkyl benzene sulfonates (LAS); C₁₀-C₂₀ primary, branched-chain and random alkyl sulfates (AS); C₁₀-C₁₈ secondary (2,3) alkyl sulfates; C₁₀-C₁₈ alkyl alkoxy sulfates (AEₓS) wherein preferably x is from 1-30;—C₁₈ alkyl alkoxy carboxylates preferably comprising 1-5 ethoxy units; mid-chain branched alkyl sulfates as discussed in U.S. Pat. No. 6,020,303 and U.S. Pat. No. 6,060,443; mid-chain branched alkyl alkoxy sulfates as discussed in U.S. Pat. No. 6,008,181 and U.S. Pat. No. 6,020,303; modified alkylbenzene sulfonate (MLAS) as discussed in WO 99/05243, WO 99/05242, WO 99/05244, WO 99/05082, WO 99/05084, WO 99/05241, WO 99/07656, WO 00/23549, and WO 00/23548.; methyl ester sulfonate (MES); and alpha-olefin sulfonate (AOS).

Nonionic Surfactants

Non-limiting examples of nonionic surfactants include: C₁₂-C₁₈ alkyl ethoxylates, such as, NEODOL® nonionic surfactants from Shell; C₆-C₁₂ alkyl phenol alkoxylates wherein the alkoxylate units are a mixture of ethyleneoxy and propyleneoxy units; C₁₂-C₁₈ alcohol and C₆-C₁₂ alkyl phenol condensates with ethylene oxide/propylene oxide block polymers such as PLURONIC® from BASF; C₁₄-C₂₂ mid-chain branched alcohols, BA, as discussed in U.S. Pat. No. 6,150,322; C₁₄-C₂₂ mid-chain branched alkyl alkoxylates, BAEₓ, wherein x 1-30, as discussed in U.S. Pat. No. 6,153,577, U.S. Pat. No. 6,020,303 and U.S. Pat 6,093,856; as discussed in U.S. Pat. No. 4,565,647 Llenado, issued Jan. 26, 1986; specifically alkylpolyglycosides as discussed in U.S. Pat. No. 4,483,780 and U.S. Pat. No. 4,483,779; Polyhydroxy fatty acid amides as discussed in U.S. Pat. No. 5,332,528, WO 92/06162, WO 93/19146, WO 93/19038, and WO 94/09099; and ether capped poly(oxyalkylated) alcohol surfactants as discussed in U.S. Pat. No. 6,482,994 and WO 01/42408.

Detergent Adjunct Materials and Methods of Use p In general, a detergent adjunct is any material required to transform a detergent composition containing only the minimum essential ingredients into a detergent composition useful for laundry, consumer, commercial and/or industrial cleaning purposes. In certain embodiments, detergent adjuncts are easily recognizable to those of skill in the art as being absolutely characteristic of detergent products, especially of detergent products intended for direct use by a consumer in a domestic environment.

The precise nature of these additional components, and levels of incorporation thereof, will depend on the physical form of the detergent composition and the nature of the cleaning operation for which it is to be used.

The detergent adjunct ingredients if used with bleach should have good stability therewith. Certain embodiments of detergent compositions herein should be boron-free and/or phosphate-free as required by legislation. Levels of detergent adjuncts are from about 0.00001% to about 99.9%, by weight of the detergent compositions. Use levels of the overall detergent compositions can vary widely depending on the intended application, ranging for example from a few ppm in solution to so-called “direct application” of the neat detergent composition to the surface to be cleaned.

Quite typically, detergent compositions herein such as laundry detergents, laundry detergent additives, hard surface cleaners, synthetic and soap-based laundry bars, fabric softeners and fabric treatment liquids, solids and treatment articles of all kinds will require several adjuncts, though certain simply formulated products, such as bleach additives, may require only, for example, an oxygen bleaching agent and a surfactant as described herein. A comprehensive list of suitable laundry or cleaning adjunct materials and methods can be found in WO 99/05242.

Adjunct Materials

Common adjuncts include builders, enzymes, enzyme stabilizing agents, bleaches, bleach activators, catalytic materials and the like polymers, excluding any materials already defined hereinabove as part of the essential component of the inventive compositions. Other adjuncts herein can include suds boosters, suds suppressors (antifoams) and the like, diverse active ingredients or specialized materials such as dispersant polymers (e.g., from BASF Corp. or Rohm & Haas) other than those described above, color speckles, anti-corrosion agents, dyes, fillers, germicides, alkalinity sources, hydrotropes, anti-oxidants, pro-perfumes, perfumes, solubilizing agents, carriers, processing aids, pigments, and, for liquid formulations, solvents, chelating agents, dye transfer inhibiting agents, dispersants, brighteners, suds suppressors, dyes, structure elasticizing agents, fabric softeners, anti-abrasion agents, hydrotropes, processing aids, and other fabric care agents. Suitable examples of such other adjuncts and levels of use are found in U.S. Pat. Nos. 5,576,282, 6,306,812 B1 and 6,326,348 B1.

Builder

The detergent compositions of the present application preferably comprise one or more detergent builders or builder systems. When present, the compositions will typically comprise at least about 1% builder, preferably from about 5%, more preferably from about 10% to about 80%, preferably to about 50%, more preferably to about 30% by weight, of detergent builder.

Builders include, but are not limited to, the alkali metal, ammonium and alkanolammonium salts of polyphosphates, alkali metal silicates, alkaline earth and alkali metal carbonates, aluminosilicate builders polycarboxylate compounds. ether hydroxypolycarboxylates, copoly-mers of maleic anhydride with ethylene or vinyl methyl ether, 1,3,5-trihydroxy benzene-2,4,6-trisulphonic acid, and carboxymethyloxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, oxydisuccinic acid, polymaleic acid, benzene 1,3,5-tricarboxylic acid, carboxymethyloxysuccinic acid, and soluble salts thereof.

Enzymes

Enzymes levels in detergents in general are from 0.0001% to 2%, preferably 0.001% to 0.2%, more preferably 0.005% to 0.1%, by weight of the composition of pure enzyme. Detergent compositions can comprise one or more of the following enzymes: proteases, amylases cellulases, lipases, cutinases, esterases, carbohydrases e.g. mannanase, pectate, lyase, cyclomaltodextringlucanotransferase, and xyloglucanase. Bleaching enzymes eventually with enhancers include e.g. peroxidases, laccases, oxygenases, (e.g. catechol 1,2 dioxygenase, lipoxygenase (WO 95/26393), (non-heme) haloperoxidases. It is common practice to modify wild-type enzymes via protein/genetic engineering techniques in order to optimize their performance in the detergent compositions.

Enzymes Stabilizers

Enzymes can be stabilized using any known stabilizer system like calcium and/or magnesium compounds, boron compounds and substituted boric acids, aromatic borate esters, peptides and peptide derivatives, polyols, low molecular weight carboxylates, relatively hydrophobic organic compounds [e.g. certain esters, diakyl glycol ethers, alcohols or alcohol alkoxylates], alkyl ether carboxylate in addition to a calcium ion source, benzamidine hypochlorite, lower aliphatic alcohols and carboxylic acids, N,N-bis(carboxymethyl) serine salts; (meth)acrylic acid-(meth)acrylic acid ester copolymer and PEG; lignin compound, polyamide oligomer, glycolic acid or its salts; poly hexa methylene bi guanide or N,N-bis-3-amino-propyl-dodecyl amine or salt; and mixtures thereof. In liquid matrix, the degradation by the proteolytic enzyme of second enzymes can be avoided by protease reversible inhibitors [e.g. peptide or protein type, in particular the modified subtilisin inhibitor of family VI and the plasminostrepin; leupeptin, peptide trifluoromethyl ketones, peptide aldehydes.

Bleach

Suitable bleaches for use in detergent composition of the present application may be selected from the group consisting of catalytic metal complexes, activated peroxygen sources, bleach activators, bleach boosters, photobleaches, free radical initiators and hyohalite bleaches. U.S. Pat. No. 5,576,282, U.S. Pat. No. 5,597,936. Suitable transition metal MRLs are readily prepared by known procedures, such as taught for example in WO 00/332601, and U.S. Pat. No. 6,225,464.

Suitable activated peroxygen sources include, but are not limited to, preformed peracids, a hydrogen peroxide source in combination with a bleach activator, or a mixture thereof. Suitable preformed peracids include, but are not limited to, compounds selected from the group consisting of percarboxylic acids and salts, percarbonic acids and salts, perimidic acids and salts, peroxymonosulfuric acids and salts, and mixtures thereof. Suitable sources of hydrogen peroxide include, but are not limited to, compounds selected from the group consisting of perborate compounds, percarbonate compounds, perphosphate compounds and mixtures thereof. Suitable types and levels of activated peroxygen sources are found in U.S. Pat. Nos. 5,576,282, 6,306,812 B1 and 6,326,348 B1 that are incorporated by reference.

Suitable bleach activators include, but are not limited to, perhydrolyzable esters and perhydrolyzable imides such as, tetraacetyl ethylene diamine, octanoylcaprolactam, benzoyloxybenzenesulphonate, nonanoyloxybenzenesulphonate, benzoylvalerolactam, dodecanoyloxybenzenesulphonate. Suitable bleach boosters include, but are not limited to, those described U.S. Pat. No. 5,817,614.

As a practical matter, and not by way of limitation, the detergent compositions and cleaning processes herein can be adjusted to provide on the order of at least one part per hundred million of catalytic metal complex in the aqueous washing. When present, hydrogen peroxide sources will typically be at levels of from about 1%, to about 30%, by weight of the detergent composition. If present, peracids or bleach activators will typically comprise from about 0.1% to about 60% by weight of the detergent composition. As a practical matter, and not by way of limitation, the detergent compositions and cleaning processes herein can be adjusted to provide on the order of at least one part per hundred million of bleach booster in the aqueous washing.

Method of Use

The present application includes a method for cleaning a situs inter alia a surface or fabric. Such method includes the steps of contacting an embodiment of Applicants' detergent composition, in neat form or diluted in a wash liquor, with at least a portion of a surface or fabric then rinsing such surface or fabric. Preferably the surface or fabric is subjected to a washing step prior to the aforementioned rinsing step. For purposes of the present application, washing includes but is not limited to, scrubbing, and mechanical agitation.

As will be appreciated by one skilled in the art, the detergent compositions of the present application are ideally suited for use in laundry applications. Accordingly, the present application includes a method for laundering a fabric. The method comprises the steps of contacting a fabric to be laundered with a laundry solution comprising at least one embodiment of a detergent composition, cleaning additive or mixture thereof comprising the present application. The fabric may comprise most any fabric capable of being laundered in normal consumer use conditions. The solution preferably has a pH of from about 8 to about 10. The compositions are preferably employed at concentrations of from about 500 ppm to about 10,000 ppm in solution. The water temperatures preferably range from about 5° C. to about 60° C. The water to fabric ratio is preferably from about 1:1 to about 20:1.

Test Methods

The amine number is determined according to the method described in DGF Einheitsmethoden—Abteilung H—Tenside, Methode H-III 20a (98) “Potentiometrische Titration des Gesamtbasenstickstoffs von Tensiden” (DGF standard methods—section H—surfactants, method H-III 20a (98) “Potentiometric titration of the total basic nitrogen I surfactants).

The acid number is determined according to the method as described in Europäisches Arzneibuch 4. Ausgabe 2002 S. 127 (Pharmacopoea Europaea, 4. ed. 2002, page 127) or DGF Einheitsmethoden—Abteilung C—Fette, Methode C-V (DGF standard methods—section F—fats, method C-V)

Alkylation is tested via the procedure in R. Preussmann et al. Arzneim.-Forschung 19, 1059 (1969).

### SYNTHISIS EXAMPLES

Step I. Synthesis of Non-Modified Polyaminoamides

At room temperature (15-20° C.) charge a polyalkylenepolyamine into a 2 l glass round bottom flask equipped with a destillation bridge. Purge the reactor with nitrogen and add x g (x is defined below in Table 1) of deionized water. The temperature will rise to about 50° C. Heat the mixture to 60° C. and add adipic acid within 5 minutes. The temperature will rise to about 100° C. Heat the reaction mixture to 120° C. and stir at this temperature for one hour. Slowly increase the temperature to 180-190° C. and distill off water and unreacted amine for at least 3 hours until the amount of condensated water had reached at least the theoretical value for a fully condensed product and the acid number is below 10 mg KOH/g. Cool the reaction mixture to between 120° C. and 180° C. and dilute with y g (y defined below) of deionized water to give a white or slightly yellow polyaminoamide solution with an active content from 60 to 90% by weight. Depending on the active content, the degree of condensation and the identity of the amine and acid component the product is a liquid of high viscosity or a solid.

The starting materials and the amounts employed are given in Table 1.

TABLE 1

| Polyamino | Amine | Amine | Acid | molar ratio | Water | Water | Active |
|---|---|---|---|---|---|---|---|
| amide | component | m [g] | [g] | amine:acid | x [g] | y [g] | Content [%] |
| A1 | DETA¹ | 587 | 780 | 20:19 | 173 | 740 | 60 |
| A2 | DETA¹ | 361 | 460 | 10:9 | 110 | 170 | 89 |
| A3 | DETA¹ | 516 | 585 | 5:4 | 129 | 240 | 88 |
| A4 | N4-Amine² | 471 | 355 | 10:9 | 115 | 185 | 85 |
| A5 | N4-Amine² | 479 | 322 | 5:4 | 120 | 180 | 81 |
| A6 | N4-Amine² | 522 | 292 | 3:2 | 131 | 186 | 80 |

¹DETA: Diethylenetriamine
²N4-Amine: N,N′-Bis(3-aminopropyl)ethylenediamine

Step II. Alkoxylation of the Non-Modified Polyamineamide
Option 1. Reaction with 1 Mol Ethylene Oxide Per Mol NH-Groups

Charge the aqueous solution of the polyaminoamide into a 2 l metal reactor and then render it inert by applying 3 to 5 bar of nitrogen 3 times. Heat the reactor contents to 90-130° C. and add the required amount of ethylene oxide was added in portions (total amount equimolar to the amino hydrogens present in the polyaminoamide) in such a way so as to slowly raise the pressure. Increase the pressure further by adding nitrogen until a pressure of 500-800 kPa (5-8 bar) is reached and then stir the reaction mixture at 90-130° C. until the pressure remains constant. Cool the reaction mixture to 70-80° C. Flush the reactor with 300 kPa (3 bar) of nitrogen and remove residual ethylene oxide on a rotary evaporator. The resulting alkoxylated polyaminoamide is yellow or lightly brown in color and depending on the active content, the degree of condensation and the identity of the amine and acid component the product is a liquid of high viscosity or a solid.

Option 2. Methods A to C

Method A:

Obtain the aqueous solution of the modified polyaminoamide according to Step 1, charge the catalyst and xylene in a 2 l metal reactor and rendered inert as described above in Option 1. Heat the mixture to 130-160° C. under a nitrogen stream to remove the water from the reaction mixture. Cool the reactor content to 120-150° C. and then add in portions ethylene oxide in such a way that the pressure slowly rises. Increase the pressure further by adding nitrogen until a pressure of 500-800 kPa (5-8 bar) is reached. Stir the reaction mixture at 120-150° C. until the pressure remains constant. Cool to 80° C. Flush the reactor with 300 kPa (3 bar) of nitrogen to remove residual ethylene oxide. Remove xylenes at 120° C. by introducing 400 kPa (4 bar) of hot steam. The alkoxylated polyaminoamide obtained is a dark brown aqueous solution with an active content of 67% and a pH of 10.5.

Method B:

Obtain the aqueous solution of the polyaminoamide according to Step 1 and mix the catalyst. Remove water and other volatile components at 80-120° C. under reduced pressure. Charge the mixture into a 2 l metal reactor and rendered inert as described above in Option I. Add at 120-150° C. the alkylene oxide in portions in such a way that the pressure slowly rises. Further increase the pressure adding nitrogen, until a pressure of 500-800 kPa (5-8 bar) is reached. Stir the reaction mixture at 120-150° C. until the pressure remains constant. In case of stepwise addition of different alkylene oxides, a period of at least 2 hours, during which the pressure remains constant, is allowed to pass after addition of each alkylene oxide before the next alkyleneoxide is added. After addition of all alkylene oxides, cool to 80-90° C. Flush the reactor with 300 kPa (3 bar) of nitrogen and remove residual ethylene oxide (alkylene oxide) is removed in a rotary evaporator.

Method C:

Remove water from the aqueous solution of the polyaminoamide obtained according to Step 1 at 80-120° C. under reduced pressure. Cool the mixture to 50° C. and add the catalyst under a nitrogen atmosphere. Remove the volatile compounds from the mixture at 80-120° C. under reduced pressure. Charge the mixture into a 2 l metal reactor and rendered inert as described above in Option I. Add at 120-150° C. the alkyleneoxide in portions in such a way that the pressure slowly rises. Increase the pressure further by adding f nitrogen, until a pressure of 500-800 kPa (5-8 bar)is reached. Stir the reaction mixture at 120-150° C. until the pressure remains constant. Cool to 80-90° C. Flush the reactor with 300 kPa (3 bar) of nitrogen and remove residual ethylene oxide on a rotary evaporator.

The starting materials and the amounts employed for the produced modified polyaminoamides are given in Table 2.

TABLE 2

| | Polyaminoamide¹⁾ | | Alkylene Oxide | | | | |
|---|---|---|---|---|---|---|---|
| | type²⁾ | amount [g]³⁾ | type⁴⁾ | [g] | [mol]⁵⁾ | Catalyst | Method |
| C1 | A1 | 205 g (69% aqu. | EO | 524 | 24 | 1.6 g 40% aqueous | A |
| | | sol. + 280 g | | | | solution of KOH | |
| | | xylenes) | | | | | |
| C2 | A2 | 125 g (92% aqu. | EO | 1154 | 44 | 0.6 g crystalline | C |
| | | sol.) | | | | potassium tert.- | |
| | | | | | | butoxide | |
| C3 | A3 | 110.1 g(86% aqu | EO | 250 | 10 | 0.47 g crystalline | B |
| | | sol.) | PO | 365 | 10 | potassium tert.- | |
| | | | EO | 665 | 24 | butoxide | |
| C4 | A3 | 105.2 (86% aqu. | EO | 609 | 24 | 0.45 g crystalline | B |
| | | sol.) | | | | potassium tert.- | |
| | | | | | | butoxide | |
| C5 | A4 | 166.5 (85% aqu. | EO | 907 | 24 | 0.71 g crystalline | B |
| | | sol.) | | | | potassium tert.- | |
| | | | | | | butoxide | |
| C6 | A5 | 166.7 (84% aqu. | EO | 1298 | 30 | 0.7 g crystalline potassium | B |
| | | sol.) | | | | tert.-butoxide | |
| C7 | A6 | 129 g (86.5% aqu. | EO | 954 | 24 | 0.56 g crystalline potassium | C |
| | | sol.) | | | | tert.-butoxide | |

¹⁾modified polyaminoamide of Step I
²⁾non-modified polyaminoamide starting material according to Step I, which is employed in Option I
³⁾amount of polyaminoamide obtained according to Step 1 as an aqueous solution
⁴⁾EO = ethylene oxide; PO = propylene oxide
⁵⁾mol alkylene oxide per mol amino bound hydrogen atoms in the non-modified polyaminoamide

Step III. Quaternisation (Examples 1 to 7):
a) Reaction with Dimethyl Sulfate

### Example 1

### (Polyaminoamide D1: [DETA:AA 20:19]+24 mol EO/NH, 75% methylquat [% of Amino Nitrogens Quaternised with Methyl Groups])

Obtain 390 g of the aqueous solution of the modified polyaminoamide C1 according to Step II (66% active content). Charge the modified polyaminoamide into a 0.5 l reaction flask under a nitrogen atmosphere. Heat the mixture to 60-70° C. and add 25.3 g of dimethyl sulfate (1 mol per mol of amino groups) in portions within 4 hours. Keep the reaction mixture at 60°-70° C. until the Preussmann test for determination of alkylating substances is negative. A modified polyaminoamide with a degree of quaternization of 75% (calculated from the amine number) is obtained as a dark brown liquid with a pH of 5.5.

### Examples 2 to 6

### General Procedure (Modified Polyaminoamides D2 to D6)

Obtain the modified polyaminoamide obtained according to Step II (100% active content). Charge the polyaminoamide into a 1 l reaction flask under a nitrogen atmosphere. Heat the mixture to 60° C. and add dimethyl sulfate in portions leading to a rise in temperature to about 70° C. after the first addition of the major amount of dimethylsulfate. Keep the reaction mixture at 70°-80° C. until Preulmann test is negative. A modified polyaminoamide with a degree of quatemization above 90% (calculated from the amine number) is obtained as a dark brown solid or viscous liquid with an acidic pH. The starting material and the amount of dimethyl sulfate being used are given in Table 3.

TABLE 3

| | | Starting | | | | |
|---|---|---|---|---|---|---|
| | | Material | | Dimethylsulfate | | quaternization* |
| Example | | type | [g] | [g] | equivalent | [%] |
| 2 | D2 | C2 | 900 | 52.2 | 0.95 | 93 |
| 3 | D3 | C3 | 800 | 43.5 | 1.0 | 92 |
| 4 | D4 | C4 | 667 | 56.5 | 0.95 | 93 |
| 5 | D5 | C5 | 916 | 89.2 | 0.93 | 93 |
| 6 | D6 | C6 | 850 | 69.9 | 0.945 | 94 |

*calculated from the amine number

b) Quatemization with Benzyl Chloride

### Example 7

### (Polyaminoamide D7: [N4-Amin:AA 3:2]+24 EO/NH, 68% Benzylquat [% of Amino Nitrogens Quatemised with Benzyl Groups])

Obtain 365 g of the modified polyaminoamide C7 obtained according to Step II (100% active content). Chare the polyaminoamide into a 1 l reaction flask under a nitrogen atmosphere and dilute with 56.4 g of distilled water. Heat the solution to 90° C. and add 28.6 g of benzyl chloride (0.75 mol per mol of amine functionalities) within 15 minutes. Keep the reaction mixture at 90° C. for 90 minutes and then add 2.5 g of a 50% by weight aqueous solution of sodium hydroxide. Stir the reaction mixture for another 3 h at 90° C. To destroy residual benzyl chloride, add a solution of 4.7 g of sodium acetate in 38 g of distilled water to the reaction mixture, and stir the obtained mixture for another 4 h at 90° C.

Step IV Introduction of Acidic Groups (Examples 8 to 14)

a) Trans-Sulfation-Process

### Examples 8 to 11

### General Procedure (Modified Polyaminoamides E1, E3, E5 and E6)

Obtain the modified polyaminoamide D1, D3, D5 or D6 according to Step III examples 1, 3, 5 and 6 (as an aqueous solution or material with greater than 98% active content). Introduce the polyaminoamide into a 1 l reaction flask under a nitrogen atmosphere and heat to 60° C. Add concentrated sulfuric acid in portions, thereby decreasing the pH of the mixture to less than or equal to 2.4. Stir the reaction mixture for 3 hours at 90° C., at a pressure of less than or equal to 20 mbar with nitrogen passing through the mixture to remove water and the methanol formed. Decompress with nitrogen and cool to 60° C. Add z g (z defined below) of a 50% by weight aqueous solution of sodium hydroxide in portions to obtain the product as a brown aqueous solution (active content greater than 95% by weight) with a pH ranging from 8 to 9. The product is either a liquid of high viscosity or a waxy solid. The type of starting material and the relative amounts of reactants are given in table 4.

TABLE 4

| | | Starting | | | | | |
|---|---|---|---|---|---|---|---|
| Ex- | | Material | | Sulfuric | NaOH sol. | Degree of | Degree of |
| ample | | type | [g] | acid [g] | z [g] | quaternization | sulfation |
| 8 | E1 | D1 | 365 | 3.8 | 7.0 | 92 | 92 |
| 9 | E3 | D3 | 400 | 6.4 | 8.2 | 92 | 78 |
| 10 | E5 | D5 | 515 | 6.1 | 6.8 | 86 | 86 |
| 11 | E6 | D6 | 450 | 4.5 | 5.3 | 81 | 82 |

b) Sulfation with Sulfuric Acid

### Example 12

### Synthesis of E2: [DETA:AA10:9]+44 EO/NH, 93% methylquat, 100% Sulfation:

Obtain 202 g of the modified polyaminoamide D2 obtained according to Step III example 2. Introduce into a 0.5 l reaction flask under a nitrogen atmosphere and heat to 60° C. Add 4 g of concentrated sulfuric acid and stir the reaction mixture for 8 hours at 90° C. and a pressure of ≦20 mbar with nitrogen passing through the mixture to remove the methanol and the condensation water formed. Decompress with nitrogen and cool to 60° C. Adjust the pH to 8.5 by adding a 50% by weight aqueous solution of sodium hydroxide. The product is obtained as a brown liquid of high viscosity.

c) Reaction with Polyphosphoric Acid

### Examples 13 and 14

### General Procedure (Modified Polyaminoamides E4 and E7)

Obtain the modified polyaminoamide D4 or D7 obtained according to Step III example 4 and 7. Introduce the polyaminoamide into a 0.25-0.5 l reaction flask under nitrogen atmosphere and heat to 65° C. (For example E7 water was first evaporated.) Add polyphosphoric acid within 10-30 min and at the same time raise the temperature to 75° C. Stir for 6 hours at 75° C. The product is obtained as a dark brown waxy solid with a pH between 2 and 3.5. The amount of the reactants and the degree of phosphation is given in Table 5.

TABLE 5

| | | starting material | | | HPO₃* | degree of |
|---|---|---|---|---|---|---|
| Example | | type | quaternization | amount [g] | [g] | phosphation |
| 13 | E4 | D4. | 93% methyl | 275 | 24.25 | 100 |
| 14 | E7 | D7. | 68% benzyl | 238 (80% | 9.05 | 50 |
| | | | | aqu. sol.) | | |

*polyphosphoric acid

An example of a suitable detergent compositions is given in Table 6 below as LD5. LD4 is given as a reference detergent composition.

TABLE 6

| | LD4 | LD5 |
|---|---|---|
| Ingredients | [% by wt.] | [% by wt.] |
| Linear alkylbenzenesulfonate | 10-15 | 10-15 |
| C₁₂₋₁₅ alcohol ethoxy_{(1.1-2.5)} sulfate | 1-5 | 1-5 |
| C₁₂₋₁₃ alcohol ethoxylate₍₇₋₉₎ | 1-5 | 1-5 |
| cocodimethyl amine oxide | 0.1-1 | 0.1-1 |
| fatty acid | 1-5 | 1-5 |
| citric acid | 1-5 | 1-5 |
| Polymer a¹ | 0.1-1.5 | |
| Polymer b² | 0.1-1.5 | |
| Polymer c³ | | 0.5-3 |
| hydroxylated castor oil (structurant) | 5-20 | 5-20 |
| Water, perfumes, dyes, and other trace | ad 100 | ad 100 |
| components | | |

¹one or more polymers according to U.S. Pat. No. 4,891,160, VanderMeer, et al.
²one or more polymers according to WO 00/105923, Price, et al.
³polymer according to any one of polyaminoamide Examples above of the present application.

All documents cited in the Detailed Description of the Invention are, are, in relevant part, incorporated herein by reference; the citation of any document is not to be construed as an admission that it is prior art with respect to the present application.

While particular embodiments of the present application have been illustrated and described, it would be obvious to those skilled in the art that various other changes and modifications can be made without departing from the spirit and scope of the application. It is therefore intended to cover in the appended claims all such changes and modifications that are within the scope of this application.

1. A detergent composition comprising:
(I) from about 0.01% to about 90% by weight of the detergent composition of a surfactant system;
(II) from about 0.01% to about 20% by weight of the detergent composition of a modified polyaminoamide comprising formula (I) 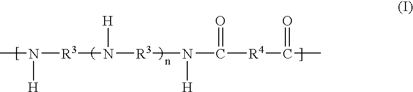
wherein n of formula (I) is an integer from 1 to 500; R³ formula (I) is selected from an C₂-C₈ alkanediyl, preferably 1,2-ethanediyl or 1,3-propane diyl; R⁴ formula (I) is selected from a chemical bond, C₁-C₂₀-alkanediyl, C₁-C₂₀-alkanediyl comprising 1 to 6 heteroatoms selected from the group consisting of oxygen, sulfur, and nitrogen, C₁-C₂₀-alkanediyl comprising 1 to 6 heteroatoms selected from the group consisting of oxygen, sulfur, and nitrogen further comprising one or more hydroxyl groups, a substituted or unsubstituted divalent aromatic radical, and mixtures thereof; wherein formula (I) comprises secondary amino groups of the polymer backbone, the amino hydrogens are selectively substituted in the modified polyaminoamide such that the modified polyaminoamide comprises partial quaternization of the secondary amino groups by selectively substituting at least one amino hydrogen with at least one alkoxy moiety of formula (II):
—(CH₂—CR¹R²—O—)ₚA (II)
wherein A of formula (II) is selected from a hydrogen or an acidic group, the acidic group being selected from —B¹—PO(OH)₂, —B¹—S(O)₂OH and —B²—COOH; such that B¹ of formula (II) is a single bond or C₁-C₆-alkanediyl; and B² of formula (II) is C₁-C₆-alkanediyl; R¹ of formula (II) is independently selected from hydrogen, C₁-C₁₂-alkyl, C₂-C₈-alkenyl, C₆-C₁₆-aryl or C₆-C₁₆-aryl-C₁-C₄-alkyl; R² of formula (II) is independently selected from hydrogen or methyl; and p of formula (II) is an integer comprising a number average of at least 10;
With the remainder of the amino hydrogens of the secondary amino groups being selected from the group comprising electron pairs, hydrogen, C₁-C₆-alkyl, C₆-C₁₆-aryl-C₁-C₄-alkyl and formula (III) Alk-O-A, wherein:
A of formula (III) is hydrogen or an acidic group, the acidic group being selected from —B¹—PO(OH)₂, —B¹—S(O)₂OH and —B²—COOH; such that B¹ of formula (III) is selected from a single bond or a C₁-C₆-alkanediyl; and B² of formula (III) is selected from a C₁-C₆-alkanediyl, and Alk of formula (III) is C₂-C₆-alkane-1,2-diyl;
the secondary amino groups of formula (I) are further selected to comprise at least one alkylating moiety of formula (IV):
—RX (IV)
Wherein R of formula (IV) is selected from the group consisting of: C₁-C₆-alkyl, C₆-C₆-aryl-C₁-C₄-alkyl and formula (III) Alk-O-A, and formula (II) —(CH₂—CR¹R²—O—)ₚA; and
X of formula (IV) is a leaving group selected from a halogen, an alkyl-halogen, a sulfate, an alkylsulfonate, an arylsulfonate, an alkyl sulfate, and mixtures thereof.

2. The detergent composition of claim 1 wherein the modified polyaminoamide further comprises aliphatic, aromatic or cycloaliphatic diamines to give the general formula (VII): 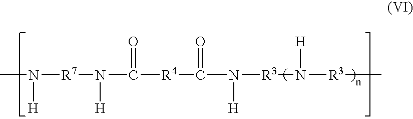
wherein R³, R⁴, and n of formula (VI) are the same as formula (I); R⁷ of formula (VI) is a bivalent organic radical carrying from 1 to 20 carbon atoms, C₁-C₂₀-alkanediyl comprising 1 to 6 heteroatoms selected from the group consisting of oxygen, sulfur, and nitrogen, C₁-C₂₀-alkanediyl, C₁-C₂₀-alkanediyl comprising 1 to 6 heteroatoms selected from the group consisting of oxygen, sulfur, and nitrogen further comprsing one or more, hydroxyl groups, a substituted or unsubstituted divalent aromatic radical, and mixtures thereof.

3. The detergent composition of either claim 1 or claim 2 wherein the modified polyaminoamide further comprises an esterification moiety for the alkoxy moiety, the alkylating moiety, and mixtures thereof, provided a hydroxyl group is present in the alkoxy moiety and the alkylating moiety.

4. The detergent composition of claim 3 wherein the esterification moiety is selected from chlorosulfonic acid, sulfur trioxide, amidosulfonic acid, polyphosphate, phosphoryl chloride, phosphorpentoxide, and mixtures thereof.

5. The detergent composition of either claim 1 or claim 2 wherein polyaminoamide comprises primary amino groups of the polymer backbone.

6. The detergent composition of claim 5 wherein the primary amino groups of the polymer backbone, the primary amino groups comprise amino hydrogens, the amino hydrogens are modified by comprising at least one alkoxy moiety of formula (II), with the remainder of the amino hydrogens of the secondary amino groups being further modified from the group consisting of electron pairs, hydrogen, C₁-C₆-alkyl, C₆-C₁₆-aryl-C₁-C₄-alkyl and formula (III) Alk-O-A, and the primary amino groups are further modified by comprising at least one alkylating moiety of formula (II).

7. The detergent composition of claim 6 wherein the modified polyaminoamide further comprises an esterification moiety for the alkoxy moiety, the alkylating moiety, and mixtures thereof when a hydroxyl group is present in the alkoxy moiety and the alkylating moiety.

8. The detergent composition of claim 7 wherein the esterification moiety is selected from chlorosulfonic acid, sulfur trioxide, amidosulfonic acid, polyphosphate, phosphoryl chloride, phosphorpentoxide, and mixtures thereof.

9. The detergent composition of claim 6 wherein the modified polyaminoamide further comprises an etherification moiety for the alkoxy moiety, the alkylating moiety, and mixtures thereof when a hydroxyl group is present in the alkoxy moiety and the alkylating moiety.

10. The detergent composition of claim 9 wherein the etherifying moieties are selected from the formula (XV) L-B³-A′, wherein A′ of formula (XV) is selected from —COOH, —SO₃H, and —PO(OH)₂, B³ of formula (XV) is selected from C₁-C₆-alkandiyl; and L of formula (XV) is a leaving group that can be replaced by nucleophiles.

11. The detergent composition of claim 1 further comprising from about 1% to about 80% by weight of the detergent composition of a builder.

12. The detergent composition of claim 1 further comprising from about 0.0001% to about 50% by weight of the detergent composition of an enzyme.

13. The detergent composition of claim 1 wherein the composition is a laundry detergent composition.

14. The detergent composition of claim 1 wherein the laundry detergent composition is a solid.

15. The detergent composition of claim 1 wherein the laundry detergent composition is a liquid.

16. A method of using the detergent composition of claim 1 for cleaning a fabric by contacting the detergent composition of claim 1 with at least a portion of the fabric and then rinsing the fabric.
